(19) United States
(12) Patent Application Publication
(10) Pub. No.: US 2003/0192613 A1
(43) Pub. Date: Oct. 16, 2003

(54) Pipe and method for resisting erosion, abrasion and corrosion

(75) Inventor: Zhen Wang, Calgary (CA)

Correspondence Address: ADE & COMPANY, 1700-360 MAIN STREET, WINNIPEG, MB, R3C3Z3, CA

(73) Assignee: Harber Industry (Canada) Inc., Sherwood Park (CA)

(21) Appl. No.: 10/121,841

(22) Filed: Apr. 15, 2002

(51) Int. Cl. F16L 9/14

(52) U.S. Cl. 138/146; 427/453; 427/456

(57) ABSTRACT

A method of resisting erosion, abrasion and corrosion in a pipe is provided in which the inner surface of a pipe having a tubular body is lined with aluminum oxide and iron. The lining is applied as a powder in the form powdered aluminum and iron oxide which are ignited to react to form aluminum oxide and iron. The ignition is self propagating and serves to melt the powder to a liquid. Rotation of the pipe within a mold about a longitudinal axis of the pipe causes the heavier iron to be displaced radially outwardly with respect to the aluminum oxide which forms an inner layer of the lining when the lining is allowed to cool. The resulting layer of aluminum oxide is both erosion and corrosion resistant while enjoying the additional benefits of the high strength of the layer of iron.

### FIELD OF THE INVENTION

The present invention relates to a method of resisting erosion in a pipe and more particularly to the pipe resulting from said method which may also exhibit abrasion and corrosion resistant characteristics.

### BACKGROUND

In pipes for conveying fluid or materials therethrough and in containers for handling fluid or materials, the desirability of resisting erosion, abrasion and corrosion along an inner surface of the pipe or container is known for extending the life thereof. Conventional methods of lining pipes include spray on coatings, however these tend to bond poorly and do not provide considerable resistance to erosion. Use of ceramic liners in pipes is also known, however this involves a complex process in which the liner is typically formed separately from the pipe and then later installed in the pipe in a time consuming and costly manner. In general, known erosion resistant coatings do not provide suitable resistance to erosion while being readily applied to pipes.

### SUMMARY

According to one aspect of the present invention there is provided a pipe comprising:

a tubular body; and

a coating comprising aluminum oxide lining an inner surface of the tubular body.

The use an aluminum oxide coating on pipe provides a durable, erosion resistant coating for pipes which can be readily applied to the pipe as described below and which also exhibits abrasion and corrosion resistant characteristics.

The aluminum oxide is preferably in a form comprising Al₂O₃.

The coating may further comprise a layer of iron adjacent the inner surface of the tubular body and a layer aluminum oxide adjacent an inner surface of the layer of iron.

The layers of aluminum oxide and iron are preferably fused onto the tubular body.

The layers of aluminum oxide and iron are preferably in a ratio of 4 Al₂O₃ to 9 Fe.

Typically, the tubular body is formed of steel.

According to a further aspect of the present invention there is provided a method of resisting erosion in a pipe comprising:

providing a pipe having a tubular body; and

lining an inner surface of the tubular body with aluminum oxide.

The method preferably includes lining the inner surface of the pipe with both aluminum oxide and iron and locating a layer of the iron directly adjacent the inner surface of the tubular body while locating a layer of the aluminum oxide adjacent an inner surface of the layer of iron.

The aluminum oxide and iron are preferably applied together as a powder. The powder preferably comprises powdered aluminum and powdered iron oxide which are reacted together to form aluminum oxide and iron wherein the ratio of aluminum to iron oxide comprises 8 Al to 3 Fe₃O₄.

The method may further include igniting the powder to react the aluminum and iron oxide together to form aluminum oxide and iron.

The aluminum oxide and iron may be separated by rotating the pipe about a respective longitudinal axis of the pipe so that the heavier iron is displaced radially outwardly with respect to the aluminum oxide.

The pipe is preferably rotated until the aluminum oxide and iron are substantially solidified.

There may be provided a rotatable mold arranged to support the pipe for rotation about the longitudinal axis of the pipe. Rotating the pipe may then be effected by rotating the mold supporting the pipe therein.

The mold may include a main tubular portion for supporting the tubular body of the pipe therein and respective end portions at each end of the main tubular portion, spanning radially inwardly from the tubular body.

The tubular body of the pipe is preferably formed of steel.

### BRIEF DESCRIPTION OF THE DRAWINGS

In the accompanying drawings, which illustrate an exemplary embodiment of the present invention:

FIG. 1 is an end view of a pipe which has been lined.

FIG. 2 is an end view of the pipe shown supported in a mold for rotating the pipe.

FIG. 3 is a side elevational view of the pipe shown supported in the mold.

FIG. 4 is a flow chart illustrating the order of operations for lining the pipe.

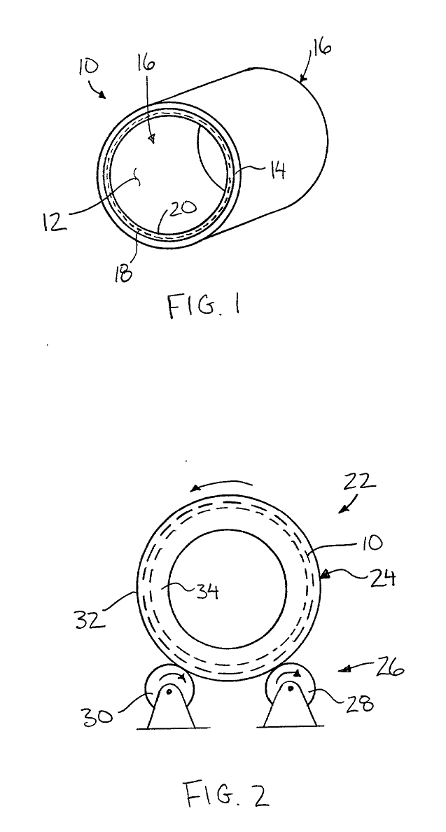

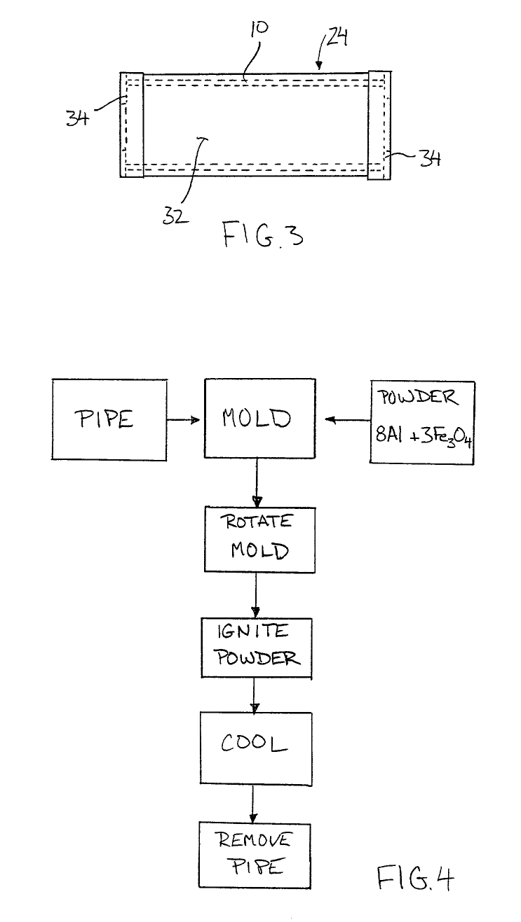

### DETAILED DESCRIPTION

Referring the accompanying drawings there is illustrated a pipe generally indicated by reference numeral 10. The pipe 10 includes a lining 12 coating an inner surface 14 thereof to prevent erosion of the inner surface while also providing a durable corrosion and abrasion resistant layer.

The pipe 10 includes a generally tubular body surrounding a longitudinal axis of the pipe. Respective ends 16 of the pipe are open for communication with adjacent sections of pipe when connected in a pipeline. The pipe is thus suitably arranged for conveying fluids and the like therethrough. The tubular body of the pipe has a steel composition.

The lining 12 of the inner surface 14 of the pipe includes a layer of iron 18 and a layer of aluminum oxide 20. The layers are fused onto the pipe such that the layer of iron 18 is located directly adjacent the inner surface 14 of the tubular body of the pipe while the aluminum oxide layer 20 is positioned radially inwardly in relation to the iron layer adjacent an inner surface of the iron layer.

The lining is applied to the pipe by an apparatus 22 arranged for coating the inner surface of the pipe. The apparatus includes a mold 24 which is supported on a suitable rotating mechanism 26. The mold 24 is arranged to snuggly receive the pipe 10 to be coated therein. The rotating mechanism 26 includes a drive wheel 28 for engaging an outer surface of the mold to rotate the mold and an idler wheel 30 for supporting the mold 24 rotatably thereon.

The mold is sufficiently rigid to resist pipe deformation when the pipe is heated as the coating is being applied to the inner surface thereof. The mold includes a tubular portion 32 which snuggly receives the pipe 10 therein and a pair of end portions 34 capping respective ends of the tubular portion. Each end portion 34 generally comprises an annular flange which spans radially inwardly from the ends of the tubular portion 32 about a full circumference of the tubular portion so as to abut respective ends of the pipe 10 when the pipe is received within the tubular portion 32 of the mold. The end portions are suitably arranged for containing a small amount of liquid adjacent an inner surface of the pipe 10. The mold includes a cooling mechanism for cooling the mold to resist deformation when the pipe is heated.

The method of operating the apparatus 22 for coating the inner surface 14 of the pipe 10 begins by first mixing aluminum powder and iron oxide powder in a ratio of 8 Al to 3 Fe₃O₄. The pipe is received within the mold 24 and capped by the end portions 34 thereof. The aluminum and iron oxide powders are distributed evenly about the inner surface 14 of the pipe within the mold which is rotated about the longitudinal axis of the tubular body of the pipe 10. Heating and igniting the powders within the pipe initiate a self-propagating reaction to produce aluminum oxide and iron in the ratio of 4 Al₂O₃ to 9 Fe. The self-propagating reaction generates sufficient heat to melt the products of the reaction so that the aluminum oxide and iron flow freely about the inner surface 14 of the pipe as a fluid. Despite the high temperatures, the rigid insulated mold resists deformation of the pipe. Continued rotation of the mold about a longitudinal axis of the pipe and the mold causes the heavier iron particles to be displaced radially outwardly in relation to the aluminum oxide by the centrifugal spinning forces. The iron thus deposits itself in an iron layer directly adjacent the inner surface 14 of the pipe while the lighter aluminum oxide forms a harder layer adjacent an inner surface of the layer of iron. Rotation of the mold continues until the iron and aluminum oxide layers have sufficiently cooled so as to mostly solidify. The pipe 10 may then be removed from the mold 24.

The method described herein may be adapted for various types of pipes or containers or other appliances for the similar purpose of resisting erosion by improving wear characteristics of the product being coated. Corrosion and abrasion resistant benefits of the aluminum oxide coating are also recognized.

While one embodiment of the present invention has been described in the foregoing, it is to be understood that other embodiments are possible within the scope of the present invention. The invention is to be considered limited solely by the scope of the appended claims.

1. A pipe comprising:
a tubular body; and
a coating comprising aluminum oxide lining an inner surface of the tubular body.

2. The pipe according to claim 1 wherein the aluminum oxide is in a form comprising Al₂O₃.

3. The pipe according to claim 1 wherein the coating comprises a layer of iron adjacent the inner surface of the tubular body and a layer aluminum oxide adjacent an inner surface of the layer of iron.

4. The pipe according to claim 3 wherein the layers of aluminum oxide and iron are fused onto the tubular body.

5. The pipe according to claim 3 wherein the layers of aluminum oxide and iron are in a ratio of 4 Al₂O₃ to 9 Fe.

6. The pipe according to claim 1 wherein the tubular body is formed of steel.

7. A method of resisting erosion in a pipe comprising:
providing a pipe having a tubular body; and
lining an inner surface of the tubular body with aluminum oxide.

8. The method according to claim 7 including applying the aluminum oxide to the pipe as a powder.

9. The method according to claim 7 including lining the inner surface of the pipe with both aluminum oxide and iron.

10. The method according to claim 9 including locating a layer of the iron directly adjacent the inner surface of the tubular body and locating a layer of the aluminum oxide adjacent an inner surface of the layer of iron.

11. The method according to claim 9 including applying the aluminum oxide and iron together as a powder.

12. The method according to claim 11 wherein the powder comprises powdered aluminum and powdered iron oxide which are reacted together to form aluminum oxide and iron.

13. The method according to claim 12 wherein the ratio of aluminum to iron oxide comprises 8 Al to 3 Fe₃O₄.

14. The method according to claim 12 including igniting the powder to react the aluminum and iron oxide together to form aluminum oxide and iron.

15. The method according to claim 12 including separating the aluminum oxide and iron by rotating the pipe about a respective longitudinal axis of the pipe.

16. The method according to claim 15 including rotating the pipe until the aluminum oxide and iron are cooled so as to be substantially solidified.

17. The method according to claim 16 including providing a rotatable mold arranged to support the pipe for rotation about the longitudinal axis of the pipe and rotating the pipe by rotating the mold supporting the pipe therein.

18. The method according to claim 17 wherein the mold includes a main tubular portion for supporting the tubular body of the pipe therein and respective end portions at each end of the main tubular portion, spanning radially inwardly from the tubular body.

19. The method according to claim 7 wherein the tubular body is formed of steel.
